(19) United States
(12) Patent Application Publication
(10) Pub. No.: US 2007/0156439 A1
(43) Pub. Date: Jul. 5, 2007

(54) Returned items revalue process

(76) Inventors: Lou Fyda, Park Ridge, IL (US); Frank Ross, Lake Zurich, IL (US)

Correspondence Address: Joseph A. Fuchs;Everest Intellectual Property Law Group, P.O. Box 708, Northbrook, IL, 60065, US

(21) Appl. No.: 11/592,358

(22) Filed: Oct. 31, 2006

Related U.S. Application Data
(60) Provisional application No. 60/731,895, filed on Oct. 31, 2005.

(51) Int. Cl. G06Q 99/00

(52) U.S. Cl. 705/1

(57) ABSTRACT

A process for processing the return of products in a single location including: (1) forecasting parts necessary for refurbishing a certain type of a returned product; (2) receiving the returned product at the single location; (3) analyzing the returned product to determine how to refurbish the products; (4) forwarding the products to a refurbishing location within the single location; (5) receiving the parts for refurbishing the products received; and (6) refurbishing the products utilizing the parts and in a manner determined.

### CROSS-REFERENCE TO RELATED APPLICATION

This application claims priority to U.S. Provisional Patent Application Ser. No. 60/731,895 filed on Oct. 31, 2005, which is incorporated herein by reference in its entirety and made a part hereof.

### FEDERALLY SPONSORED RESEARCH OR DEVELOPMENT

Not Applicable.

### BACKGROUND OF THE INVENTION

1. Technical Field

The present invention relates to electronic commerce. More particularly, the present invention provides a methodology for processing at a revalue center location returned merchandise item purchased from a remote location including one of numerous possible process steps including repackaging, refurbishing, remarketing and or reselling the returned item.

2. Background Art

The term “reverse logistics” refers to an industry dealing with the returns of consumer items. Although this term encompasses a broad range of methodologies, systems and functions; no process, known to the inventors, provides a fully integrated processing method from the beginning, when the items are planned for return, to completion, when the returned items have gone through value-added processing and are then sold to another user in the next market.

The present invention provides a “cradle-to-cradle” returns processing methodology. One principal objective of this methodology is to acquire the maximum financial return inherent in the returned item while protecting the prior owner of the item from potential liabilities. The process may include: (1) forecasting returns and pre-planning parts availability prior to actually receiving returned items; (2) processing items through a cascading revalue logic matrix to garner the maximum financial return from the residual value of the items; (3) ensuring effective liability protection to the returned item's owner with respect to resident data that may exist in an item's storage media and/or improper waste disposal; and (4) providing for the remarketing function to direct the return processing function to customize items' outputs to specific next market channels in advance; thereby reducing costly double-handling and delay in the items' turnaround time that tend to rapidly erode items' value.

This processing methodology applies to productive assets that have reached the end of their initial useful life. Assets include, but are not limited to, such as personal computers, servers, printers, meters, communication equipment and copiers. Such items typically possess residual value that can be recouped through appropriate refurbishment reconditioning processes and effective remarketing management as described below.

These and other aspects and attributes of the present invention will be discussed with reference to the following drawings and accompanying specification

### BRIEF DESCRIPTION OF THE DRAWINGS

FIGS. 1A, B show a schematic block diagram of the process of the present invention.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

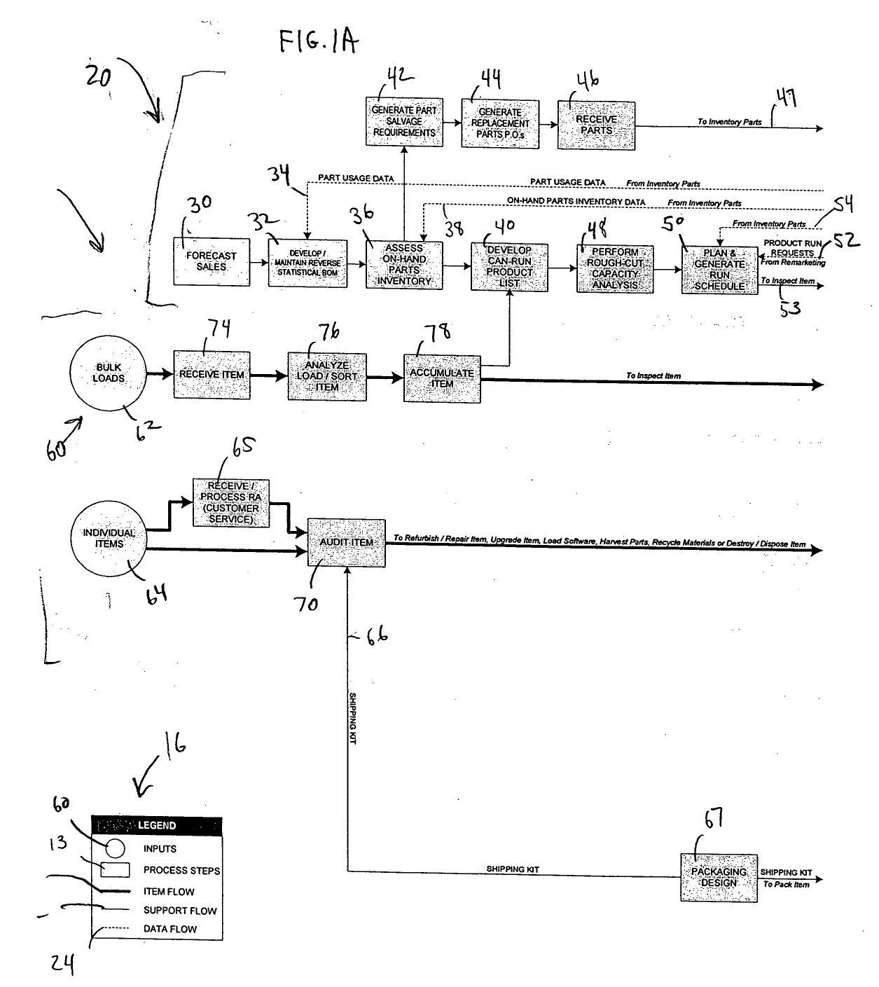

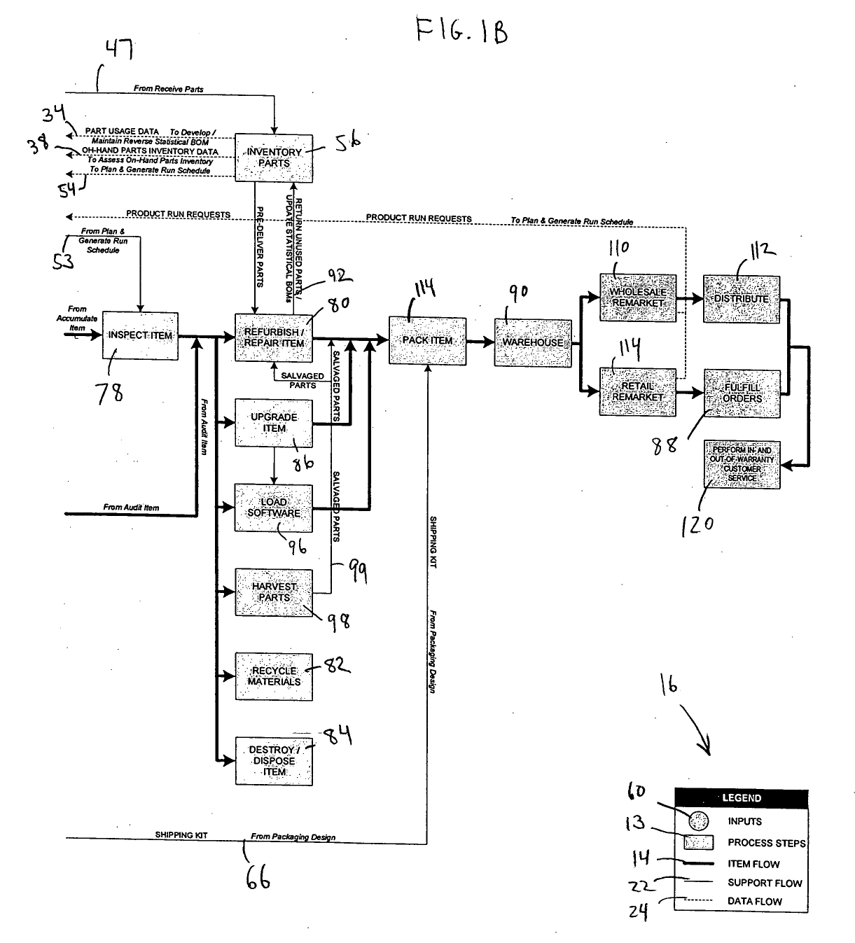

FIGS. 1A, B show a block diagram 10 of the processes of the present invention. The process includes two principal sub-processes, Item Flow and Support Flow. The Item Flow sub-process 12 is for physically handling and placing the item in a condition to maximize the value of the returned item. The Item Flow process 12 includes numerous possible steps schematically represented by rectangular boxes 13 connected by a bold, thick line 14. A legend 16 provides a key to interpreting FIGS. 1A, B. The Support Flow sub-process 20 includes the steps taken to schedule, plan and direct how an item will be processed and the steps that will be taken in the Item Flow sub-process. The steps taken in the Support Flow sub-processes are schematically represented by rectangular boxes connected by a thin line 22. Dashed lines 24 indicate the flow of data to support a step within the entire process 10.

The Support Flow sub-process includes numerous steps including the step of forecasting sales 30 of a new item. A new item is one that is placed on sale to a consumer. Sales are forecasted for a new item for at least a three-month period into the future. A projected volume of returned items from those new items sales is determined based upon historical return rates of similar items and expectations associated with the new items' use, quality, and customer's perception of the items' utility. Items returns can result from buyer's remorse in which the items did not meet expectations or was incorrectly purchased to meet a need, or possibly, poor quality that failed to meet the need. With respect to end-of-use assets, projections of item volumes are made based upon the number of items in the installed base and their expected service life.

The Support Flow sub-processes also include the step of developing and maintaining a reverse statistical bill of materials (BOM) 32. All parts, including accessories, for each item model expected to be returned, are entered into a software-supported material requirements planning system, as is well know to those of ordinary skill in the art, along with their expected replacement rate per item returned. Part usage data is supplied 34 from prior refurbishment steps as will be discussed below. This BOM is the component of the planning process that enables parts to be salvaged or procured in advance of receiving returned items thereby significantly shortening the entire revalue process 10, and, therefore, improving or optimizing the monetary yield from the process 10.

In a preferred form of the invention, the Support Flow sub-process 20 will include the step of assessing an on-hands parts inventory 36. Parts inventories are queried 38 from the material requirements planning system to determine the on-hand availability of parts against projected and actual return volume by item model. This information is used to develop a “Can-Run” Items List 40, to generate salvage part requirements 42 for refurbishment scheduling, to generate purchase orders 44 for replacement parts to reestablish or replenish on-hand part inventories, to schedule a date for receiving parts 46 and to notify 47 the inventory parts department to expect shipment of parts on the scheduled date.

To determine what on-hand items returns can be processed in the Item Flow subprocess 12, such as refurbishing, repairing, upgrading etc. of a returned item, a comparison is made between the BOM requirements and the on-hand inventory of all parts required. If the on-hand quantity of parts, for all parts required, per the BOM exceeds the quantity indicated BOM, the returns for those items are determined to be available for scheduling 40 (i.e., “can-run”). If the quantity of on-hand parts is not sufficient to process all on-hand returns for an item, the quantity of returns equal to the lowest on-hand part inventory for the item can be scheduled.

The can-run list of items and part salvage requirements are compared against the available productive capacity of each processing step to determine if sufficient capacity exists to process the items through each step 48. The next step is to plan and generate a run schedule 50 which is transmitted 53 for use in the Item Flow 12 subprocess. The results from the rough-cut capacity analysis 48, along with any requests from remarketing 52 to process specific items, are utilized to establish a processing schedule for each processing step. During this exercise, quantities of items scheduled for each processing step may be adjusted along with modification and/or redeployment of resources to create the schedule. Once completed, the schedule is submitted to each processing step for execution. Having a schedule consisting of only “can-run” items in advance allows for parts to be pulled from inventory 54 and staged at each required processing step prior to each item's run thereby enhancing item throughputs and yields while reducing and, at times, eliminating the multiple handling of items between processes that are associated with non-forecasted and/or processing real-time part salvaging methodologies.

Additionally, having remarketing request input 52 in advance of scheduling allows returns processing to generate customized items for specific remarketing channels. This avoids or reduces the higher cost of getting this information after processing is completed so that the item can be placed in a customized form for resale instead of being prepared in a generic form which later may have to be repackaged or reconfigured into a customized form thereby adding redundant steps. Several examples of this situation exist between wholesale and retail remarketing channels such as: individual boxing versus bulk pallet loads, “as-is” versus refurbished items conditions, full versus partial accessory kits with items, and items with or without original owner's/instruction manuals. Revalue items destined for next market channels all require these questions to be answered. If a timely communication channel does not exist between the remarketing and return processing functions, the processing function must commit and is required to guess at the form of the final items' output, or even worse from a processing cost standpoint, set the items aside into a “hold” status until further instructions are provided. This situation absorbs additional floor space and support resources while slowing down the turnaround time of the items, allowing them to further depreciate.

For parts determined to have on-hand inventory quantities insufficient to meet projected return volume processing, an inventory replenishment requirement is determined 42. For items that have configurations which allow for the disassembly and harvesting of parts cost-effectively (i.e., at a cost that is less than the purchase or procurement of new replacement parts), and possess sufficient return volume of functionally defective or rejected items to provide sufficient supply, a part salvage requirement 42 is established for scheduling. For parts determined to have on-hand inventory quantities insufficient to meet projected return volume processing, creating an inventory of replenishment requirement, but do not meet the criteria for part salvaging as described above, a purchase order 44 is generated for new replacement parts.

When a replacement parts shipment arrives 46 at the revalue center, the contents of the shipment are matched against the associated part purchase orders to ensure all parts requested have been delivered 46. Errors or omissions included with the shipment are reconciled with the supplier of the parts (e.g., OEM, local wholesaler). The correctly delivered parts are entered into the inventory management system and made available for planning, scheduling and processing.

The term “parts” can include any aspect associated with an item including but not limited to individual components (both functional and cosmetic), sub-assemblies, accessories, packaging materials, software and owner's and instruction manuals. Parts inventory is controlled within the inventory management system as is well known to those skilled in the art. This system allows for parts to be entered into or taken out of inventory as necessary to support the various process steps. Parts are entered into inventory when received from outside sources/suppliers, from the harvest parts processing step, load software step or the refurbish/repair processing step (these steps will be discussed below) when excess parts are returned from a batch load or bench stock is no longer required for a discontinued high-volume item. These parts are identified via specific part number bar codes and descriptions then scanned into specific inventory locations for easy retrieval when needed.

The process steps requiring parts to be taken from inventory include item refurbish/repair 80, item upgrade 86, load software 96, and pack 114 (for part sales, replacements and order fulfillment).

The refurbish/repair processing step 80 requires parts to be “pre-delivered” and staged in advance of processing an item batch run or be available in bench stock inventory prior to initiation of high volume item processing. This requirement is necessary to ensure all items scheduled are processed to completion in one run. Failure to do so typically results in items having to be returned to stock to await parts. This causes issues such as double-handling inefficiencies, increase storage costs and time delays in getting the items back into the market. As product life cycles continue to shorten due to rapid changes in technology, the devaluation of items over time accelerates. Therefore, timely and cost-effective processing methods are necessary to improve the overall financial outcome of returned items. The item upgrade 86 and load software 96 processing steps require parts to be made available in advance for similar reasons to what is described above. Parts or software necessary to enhance an items value for resale are provided to these steps in advance for the same resulting benefits.

Parts that have been harvested from items for resale are picked from inventory and repackaged in appropriate aftermarket cartons for fulfillment of customer part orders.

Turning now to the Item Flow process steps 12, FIGS. 1A, B show input of returned items to the revalue center inside a circle symbol 60. Items can arrive as bulk loads 62 or as individual items 64. Prior to receiving any item a customer will have purchased an item, for example, from a retail location, from a catalogue order or Internet purchase, and, for one reason or another wishes to return the item for a money credit, product exchange or to obtain a repair of the purchased item. Once a return is deemed the best resolution to the customer's problem, a proof of purchase is requested to validate in-warranty status. If the purchase date is within the warranty period, a Return Authorization (RA) is granted 65. The returnee can convey the item to the retailer who sold the item and allow the retailer to send the returned item to the revalue center or the customer can obtain instructions from where the item was purchased or elsewhere on how to return the item purchased to the revalue center. All pertinent information about the returnee will be recorded and the request is entered into the database for processing and tracking.

Upon receipt by the revalue center of an individual item 64, an audit 70 begins by segregating the returned item from its packaging or shipping material followed by a cleaning the item to ensure a thorough inspection. Dunnage (i.e., stretch-film, cardboard, etc.) and packaging material is collected for recycling whenever possible or discarded accordingly. A detailed inspection is performed on each item to identify any gross physical damage or abuse and to assess the cosmetic condition. The item is then tested to verify functionality and to identify component failures. All audit data (serial number, configuration, etc.), pertinent inspection and quality grade information (per established functional and cosmetic criteria) is entered into an asset management system for asset tracking and report generation. While the present invention utilizes a proprietary asset management system, similar systems are available for purchase and are well know to those of ordinary skill in the art. This system also provides customized audit reporting to meet the requirements of the seller or manufacturer of the returned item in terms of data capture, frequency of reporting and format.

For returned items that contain information in an electronic format, such as on a hard drive, computer memory, flash drive or other data storage device, the audit process includes ensuring the data is rendered permanently inaccessible. Accordingly, data-security-protection measures consistent with DoD 5220.22-M protocol are implemented and include a “sanitize” data overwrite or certified physical destruction on the item to meet each item owner's specifications. The processing information is maintained by individual item serial numbers or descriptions for historical archiving and record-keeping purposes. This step allows the item to be remarketed or reused by another end-user with confidence that potential liabilities associated with disseminating confidential information stored on the item have been mitigated or eliminated.

Upon completion of the audit step 70, the item is routed to the next appropriate process step consistent with the item's condition and current market value. If the item is found to have no defects it is designated as No Problem Found (NPF) and such items are cleaned and readied for resale or redistribution.

For receipt 74 of bulk load shipments at the revalue center of items 62 (including accessories and supplies) in full and partial truckloads via common carriers or package carriers (such as UPS, FED EX, etc.) each item/carton/box is verified against accompanying paperwork (Bill of Lading, etc.) to ensure items and quantities match. The item, carton, and/or box is then visually inspected for damage. Any damage found is noted accordingly and submitted to the freight carrier. Copies of paperwork and digital images indicating damage are sent to the item owner for resolution. When necessary, packaging/shipping recommendations and materials are forwarded 67 to the sender, (i.e., shipping kit 66) in advance to reduce the potential of item freight damage.

Each pallet of items is identified and entered into a software-supported warehouse management system, as is well known to those skilled in the art, to stage it for the next step of Analyze Load/Sort Items processing step 76. In this step the items are first analyzed for the desired time to prepare the item for resale or other disposition. Items requiring fast completion of processing due to market conditions or other time requirements, as opposed to targeting potentially higher yields and economies of scale through volume accumulation and processing, will bypass this step and go immediately to the Inspect Item step 78. These items are deemed “Fast-track Items.”

For non-Fast-track Items, staged pallets of received items are unpacked. Each carton or box is opened and the contents are analyzed to verify quantities and to collect the necessary returned item information. Information captured regarding the receipt of the item includes the date received, customer received from, RMA number—if available, model number, etc. This information is electronically transmitted to the item owner's accounting department on a regular basis for financial accounting and/or end-user customer crediting. When economically advantageous, accessories/supplies that remain unopened and are in A-grade condition (new) are segregated for reuse/resale. Excessively damaged product or supplies are scrapped. All dunnage is collected for recycling (where possible) or discarded into the trash.

Items (and accessories/supplies/parts) deemed to be in good condition and reusable or re-sellable are sorted into individual models or model “families” based on volume and refurbishing characteristics or shipping destination (e.g., Return-To-Vendor or “RTV”). A pallet sort position is established for each sort requirement and is monitored for cycle turnover. In other words, if a sort position does not fill within a specified time that position may be combined with other slow-moving positions to increase throughput and keep the item moving through the process. When a pallet becomes full, it is stretch-wrapped and taken to an area set aside to stage all sorted product until a sufficient quantity is accumulated for the appropriate shipment to an outside destination (e.g., RTV items back to vendor) or scheduled for an efficient, higher-yield refurbishment run.

Returned items of significant volume and/or cost are accumulated 78 for efficient processing and high yield. By allowing for some item accumulation, the planning and parts management functions are provided with the opportunity to schedule to ensure optimum run output is achieved. Low volume and/or low cost items do not warrant the costs of substantial planning and processing, so they typically are not accumulated so they can be turned around quickly.

All returned items are inspected 78 for cosmetic flaws. Functional tests are performed to ensure the item is in proper working condition. If the item does not have any functional or cosmetic damage, it is graded either as an “A” (new) item or “B” (like new) item. To be deemed A-grade, a unit must appear like new (i.e., never been operated). Items deemed B-grade are wiped down to remove dust, fingerprints, etc. and packaged in an appropriate aftermarket carton with an owner's/instruction manual and/or any other accessories as deemed by the items' owner or remarketing. A- and B-grade items are palletized and staged for Order Fulfillment 88 or Warehousing 90 awaiting resale.

If the item has a functional failure or cosmetic damage, it is sent to the Refurbish/Repair processing step 80 for diagnosis, part selection and repair. If a unit is damaged beyond the acceptable economic threshold, it is deemed F-grade and sent to either the Recycle Materials 82 or Destroy/Dispose Item 84 process step as appropriate for the item.

Items possessing significant market value, yet found to be functionally defective or cosmetically damaged during inspection, are repaired if deemed economical. The repair consisting of a part replacement, fix, or adjustment is performed and the item is then re-tested for the diagnosed problem to ensure no problems are found. If the item functions properly, it is deemed C-grade (refurbished) and a refurbished sticker or stamp is applied. All failure information is recorded. The item is wiped down to remove dust, fingerprints, etc. and repackaged in an appropriate aftermarket carton with an owner's/instruction manual and/or any other accessories as deemed by the items' owner or remarketing. The items are palletized and staged for the Item Upgrade 86, Fulfill Order 88 or Warehousing 90 process step per the applicable business rules for the item.

If an item is deemed non-repairable (F-grade), it is set aside until the accumulated items reach a pre-determined quantity. The items are then disassembled to recover usable parts on an as-needed basis to maintain inventory within the required quantity range. Non-repairable items and unusable parts exceeding the necessary quantities are sent to either the Recycle Materials 82 or Destroy/Dispose Item 84 process step as appropriate for the item.

All repair part requirements are recorded 92 to develop and maintain statistical Bills of Materials (BOMs) for each item for future processing runs. This statistical BOM is used to order parts and supplies to ensure the necessary on-hand inventories are maintained. This information also assists in parts ordering from vendors and can be provided along with reasons for the return of each item to the original equipment manufacturers (OEMs) for engineering changes on high-failure components to improve future item designs. Failure codes can include but not be limited to determinations such as damaged, high-use (or wear), malfunction, missing and rework. The analysis of parts usage and their condition helps to reduce returns, increase customer satisfaction, and realize costs.

Many items are potential candidates for some level of upgrade 86, expanding their useful life and enhancing their intrinsic value. For example, a fully functional “mid-tier” personal computer (PC) in good cosmetic condition is very easily remarketed with a simple upgrade of additional memory and/or a larger hard drive. Higher end units may be candidates for wireless NICs, CD-RW or DVD-RWs. Upgrade decisions are based on market conditions for each item type and vintage. If an item meets the upgrade criteria, the necessary upgrades are made via part or component replacement and/or addition and the item is functionally tested to ensure performance. If the item functions properly, a refurbished sticker or stamp is applied. All failure information is recorded. The item is wiped down to remove dust, fingerprints, etc. and packaged in an appropriate aftermarket carton with an owner's/instruction manual and/or any other accessories it requires. The items are palletized and staged for either the Fulfill Order 88 or Warehousing 90 process step per the applicable business rules for the item.

When required and applicable to the item, in process step 96 operating system software, custom software packages and application software (when proof of license is provided) is loaded into the storage media to provide a “Plug and Play” experience for the next end-user of the item.

During a Harvest Parts step 98, assets that no longer possess significant market value, or are found to be functionally defective during the Audit Item 70 or Inspect Item 78 process steps are harvested for valuable aftermarket parts and components. Harvested components are utilized 99 as replacements for repairs or made available for resale in the aftermarket. The desired parts are extracted from the item, packaged and identified per specification via bar code labeling, then warehoused for future retrieval.

All items deemed un-repairable, un-remarketable or have no parts worth harvesting are assessed for valuable materials and economic recycling 82 opportunities. These items are disassembled to separate materials into their individual classes and grades (i.e. plastics, precious metals, etc.) for separate material sale or are shredded or chipped to be sold into the material aftermarket as aggregate raw material. In either case, the process follows applicable EPA, state and federal regulations. Typically, a Certificate of Destruction is issued to the item owner to provide an audit trail. Items that do not possess any potential material value are sent to the Destroy/Disposal 84 process step.

Items not eligible for recycling are properly disposed of following applicable EPA, state and federal regulations. Typically, a Certificate of Destruction is issued to the item owner to provide an audit trail.

Items that are designated for warehousing are stored to fulfill customer orders or exchanges; or for distribution to other destinations as directed. All warehoused items are scanned into an RF-based warehouse management system to ensure the proper handling of items and total inventory control in real time. This inventory is made available to outside parties electronically or in hardcopy format as necessary to meet business needs.

In a process step Wholesale Remarket 110, items are remarketed through a variety of wholesale channels depending on their type, grade and model year vintage. The channels could include business entities such as brokers, private auction groups, and product wholesalers to name a few. Items may be committed to standing sales orders prior to their arrival or processing at the revalue center or once the items have been placed as a finished good in the warehouse inventory upon completion of processing. Often, the remarketing function will provide instructions to the various process steps to achieve the desired outcome for the remarketing event of the item. These instructions may include aspects such as timely availability through a process, product information capture requirements and final package configurations to name a few. Sales orders are sent to the Distribute process step 112 for shipment.

In the Distribute process step 112, upon receipt of sales orders and shipping instructions, the required items are pulled from inventory and staged for shipment. All necessary paperwork is prepared and the items are loaded into a truck for shipment. Copies of all pertinent paperwork are forwarded onto the necessary parties (typically the shipment destination or next owner of the item).

In the process step Retail Remarket 114, items are remarketed through a variety of retail channels directly to the next end-users. These channels include but are not limited to direct to consumer telephone sales, e-commerce/internet sales, and discount outlet stores. Items may be committed to standing sales orders prior to their arrival or processing at the revalue center or once the items have been placed as a finished good in the warehouse inventory upon completion of processing. Often, the remarketing function will provide instructions to the various process steps to achieve the desired outcome for the remarketing event of the item. These instructions may include aspects such as timely availability through a process, product information capture requirements and final package configurations to name a few. Sales orders are sent to the Fulfill Orders process step 88 for shipment.

In the process step Fulfill Order 88, items sold to end-users are fulfilled (or exchanged through customer service) from the warehouse. Sales orders are received electronically or via hardcopy or fax. The item is picked from inventory and the necessary shipping documents are generated (labels, Bills of Lading, packing slips). The item is packaged 114 (if outer pack is required) and labeled appropriately for shipment. The item is then staged for pickup by the end-user or carrier (i.e. UPS, Federal Express, etc.). When item is shipped, order shipment confirmations are sent to the end-user customer electronically (or via other preferred method).

In process step 67, in order to protect the items, minimize damage and reduce shipping and storage costs, packaging needs are assessed and an appropriate design is developed. Designs are tested to ensure they meet requisite standards.

The process step Perform-In-And Out of Warranty Customer Service 120, following the sale, customer service can be offered to support the end-user. This can include the handling of customer calls through a call center, issuing Return Authorizations (RAs), and the receipt, repair and return shipment of items requiring repair.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

We claim:

1. A process for processing the return of merchandise items, which may have parts and accessories, in a single location comprising:
forecasting the volume of sales of a new merchandise item to define a forecasted sales volume;
projecting a quantity of the new merchandise items that will be returned to the single location in part based on the forecasted sales volume to define a projected quantity of returned merchandise items;
estimating the quantity of the parts or the accessories necessary to refurbish, upgrade or repair the projected quantity of returned merchandise items to define an on-hand parts requirement;
receiving at the single location a quantity of returned merchandise items;
analyzing the returned merchandise items to determine whether to do one of the following process steps selected from the group consisting of: refurbish, repair, upgrade, harvest parts, destroy, render data permanently inaccessible, dispose of, and recycle; and
processing the returned merchandise items in a manner consistent with the analysis to define a quantity of revalued products.

2. The process of claim 1 further comprising:
reselling one of the revalued products to a purchaser; and
shipping the revalued product to the purchaser.

3. The process of claim 1 further comprising:
obtaining a quantity of parts in inventory at the single location equal to the on-hands parts quantity; and
initiating the processing of a quantity of returned merchandise items.

4. The process of claim 1 comprising:
determining that a returned item cannot be refurbished, upgraded or resold; and
completing processing of the returned item in a manner selected from the group consisting of: harvesting parts from the returned item, harvesting accessories from the returned item, destroying the returned item, harvesting material from the returned item, and recycling the returned item.

5. The process of claim 1 wherein the returned item is a personal computer, the process comprising:
upgrading the personal computer in a manner selected from the group consisting of: increasing the RAM, replacing a hard-drive, and loading additional software into the memory of the personal computer.

6. The process of claim 1 comprising:
removing a returned item from the packaging in which it was initially purchased; and
placing this returned item into a different container for resale in an aftermarket.

7. The process of claim 1 comprising:
refurbishing a returned merchandise item to define a refurbished item;
marking the refurbished item to indicate to a consumer the item is a refurbished item; and
reselling the refurbished item in an aftermarket.

8. The process of claim 1 comprising;
repairing a returned merchandise item to define a repaired item;
testing the repaired item to ensure proper working order of the repaired item; and
reselling the repaired item in an aftermarket.

9. The process of claim 1 comprising:
determining that it is not economically practical to repair or refurbish a returned merchandise item;
destroying the item; and
preparing a certificate of destruction to verify the item has been destroyed.
